(19) United States
(12) Patent Application Publication
(10) Pub. No.: US 2008/0043962 A1
(43) Pub. Date: Feb. 21, 2008

(54) METHODS, SYSTEMS, AND COMPUTER PROGRAM PRODUCTS FOR IMPLEMENTING ENHANCED CONFERENCING SERVICES

(75) Inventor: William Daniell, Kennesaw, GA (US)

Correspondence Address: CANTOR COLBURN LLP - BELLSOUTH, 55 GRIFFIN ROAD SOUTH, BLOOMFIELD, CT, 06002, US

(73) Assignee: BELLSOUTH INTELLECTUAL PROPERTY CORPORATION, Wilmington, DE (US)

(21) Appl. No.: 11/465,531

(22) Filed: Aug. 18, 2006

(51) Int. Cl. H04M 3/42

(52) U.S. Cl. 379/202.01

(57) ABSTRACT

A method, system, and computer program product for implementing conferencing services is provided. The method includes presenting content frames in a shared communication environment, each of the content frames corresponding to a source device that provides input as a participant in a conference. The method also includes identifying a source device in response to a trigger event caused by the source device. The method further includes modifying presentation of the content frame corresponding to the identified source device.

### BACKGROUND OF THE INVENTION

The present invention relates generally to interactive conferencing, and more particularly, to methods, systems, and computer program products for implementing enhanced conferencing services.

Interactive telecommunication technologies provide the ability for multiple parties to participate in bi-directional communications in a shared communications environment. Services facilitated by groupware applications, such as Internet chat, e-meetings, and video conferencing provide a convenient venue for remotely located individuals to share information, conduct seminars, consult on business matters, and perform other useful activities.

These services are implemented over a variety of transmission mediums, such as closed circuit televisions via cabling, bi-directional radio frequency (e.g., UHF or VHF) links, mobile links to satellites, and more recently, digital telephony transmission networks (e.g., ISDN) and Internet-Protocol (IP) based conferencing systems.

With the advent of video compression technologies and lowered costs of implementation, these services are now readily available for consumer use. As a result, numerous groupware vendors and service providers have entered the market, offering various conferencing services. In order to stay competitive, such vendors and service providers are looking to provide value-added services that will enhance the overall conferencing experience for their customers.

What is needed, therefore, is a conferencing service that includes enhanced functionality for its participants.

### BRIEF SUMMARY OF THE INVENTION

Exemplary embodiments include a method, system, and computer program product for implementing conferencing services is provided. The method includes presenting content frames in a shared communication environment, each of the content frames corresponding to a source device that provides input as a participant in a conference. The method also includes identifying a source device in response to a trigger event caused by the source device. The method further includes modifying presentation of the content frame corresponding to the identified source device.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a block diagram depicting a system upon which the enhanced conferencing services may be implemented in exemplary embodiments;

FIG. 2 is a flow diagram describing a process for implementing the enhanced conferencing services in exemplary embodiments; and

FIGS. 3A-3B are sample display screens illustrating video frames for conferencing participants in exemplary embodiments.

The detailed description explains the exemplary embodiments, together with advantages and features, by way of example with reference to the drawings.

### DETAILED DESCRIPTION OF EXEMPLARY EMBODIMENTS

A method, system, and computer program product for providing enhanced conferencing services is provided in accordance with exemplary embodiments. The enhanced conferencing services facilitate group conferences among various participants in a shared communication environment. The conferencing may include content frames that are presented to participants in the conference where each content frame corresponds to a participant. The conferencing services identify a triggering event (e.g., a voice/audio input, video input, static image, etc.) that is defined via the conferencing services. For example, a triggering event may be defined by an active participant in the conference (e.g., a participant that is initiating a voice communication). Upon the occurrence of the triggering event, one or more content frames associated with the triggering event are modified. This modification enables participants to distinguish one or more content frames from the group in response to, and based upon, the triggering event.

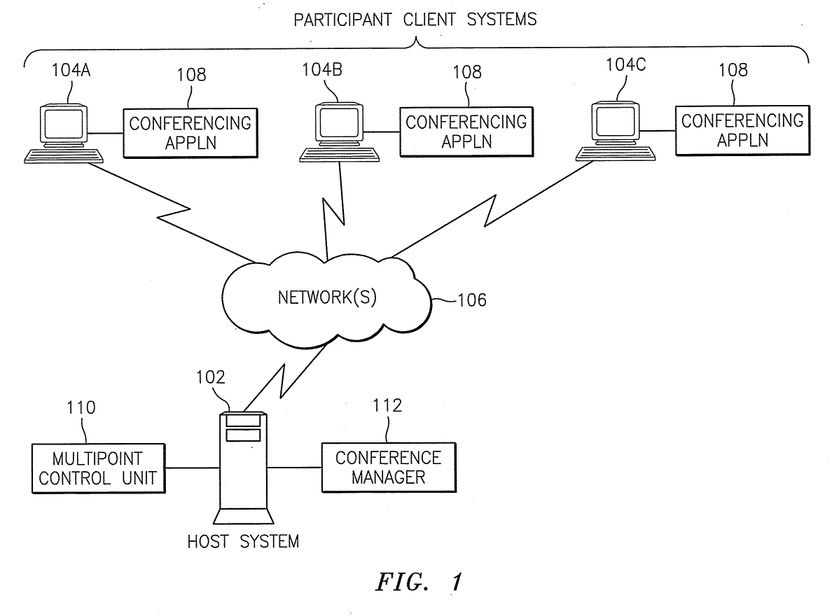

Turning now to FIG. 1, a system upon which the enhanced conferencing services may be implemented in accordance with exemplary embodiments will now be described. The system of FIG. 1 includes a host system 102 in communication with participant client systems 104A-104C over one or more networks 106. Participant client systems 104A-104C are associated with to users of the enhanced conferencing services; that is, individuals who are participating in a conference that is conducted in a shared communications environment, or who are scheduled to participate in an upcoming conference. The conference may be implemented via any type of interactive communications. However, for illustrative purposes, the conferencing activities described herein will be described with respect to audio/video conferencing.

In exemplary embodiments, participant client systems 104A-104C are implemented by devices enabled with teleconferencing components. For example, as shown in FIG. 1, the devices represent personal computers that are equipped with video teleconferencing components (e.g., plug-ins), including input components, output components, and software/hardware that provides compression/decompression (codec) functionality. Other examples of teleconferencing-enabled devices include personal digital assistants (PDAs), cellular telephones, television sets, and telephones, to name a few. The input elements of teleconferencing devices may include, e.g., a Web camera (WebCam) that includes an image sensor (e.g., complementary metal-oxide semiconductor (CMOS) chip or charge-coupled device (CCD), etc.) for reading images that are transmitted to the client system via, e.g., USB cabling or by wireless means). The input components may also include audio input devices, such as a microphone for receiving voice communications from a user of the participant client system. The audio signals received by the microphone are likewise transmitted to the client system for processing via, e.g., USB cabling. These components enable inputs from teleconferencing devices (e.g., participant client systems 104A-104C), such as audio inputs, video inputs, static images, etc.

In exemplary embodiments, each of participant client systems 104A-104C includes a processor that executes a conferencing application 108. Conferencing application 108 may be a proprietary tool or may be a commercial product that enables users of participant client systems 104A-104C to engage in interactive conferencing activities (e.g., e-meetings, collaboration, chat, etc.). The video teleconferencing components implemented by participant client systems 104A-104C may utilize adopted standards for conferencing, such as H.323, a standard used for conducting video over IP and Voice over IP. Web conferencing standards, such as ITU T.120 may be used by participant client systems 104A-104C.

While only three participant client systems 104A-104C are shown in the system of FIG. 1 for ease of explanation, it will be understood that any number of participant client systems 104A-104C may be serviced by the host system 102.

In exemplary embodiments, host system 102 is a service provider of the enhanced conferencing services described herein. Host system 102 may be implemented using a high-speed processing device, e.g., mainframe computer that services a number of participant client systems. In alternative exemplary embodiments, the enhanced conferencing services may be implemented via one of participant client systems 104A-104C, which acts as a control system (e.g., supervisor) for the remaining participating client systems.

In exemplary embodiments, host system 102 implements a multi-point control unit 110 (MCU 110) that interconnects calls or communications received from various sources, such as participant client systems 104A-104C, such that a conference among the interconnected client systems is facilitated. The MCU 110 receives communications (i.e., inputs) from participating client systems (e.g., participant client systems 104A-104C) at a configured number of ports residing on the MCU 110 and combines these inputs into a shared communications environment. Thus, in one aspect, MCU 110 acts as a bridging device among participants in a conference. If there are a greater number of participating client systems than there are physical ports on the MCU 110, host system 102 may be configured with multiple MCUs 110 that are interconnected as needed. MCU 110 may be implemented using software or a combination of hardware and software elements.

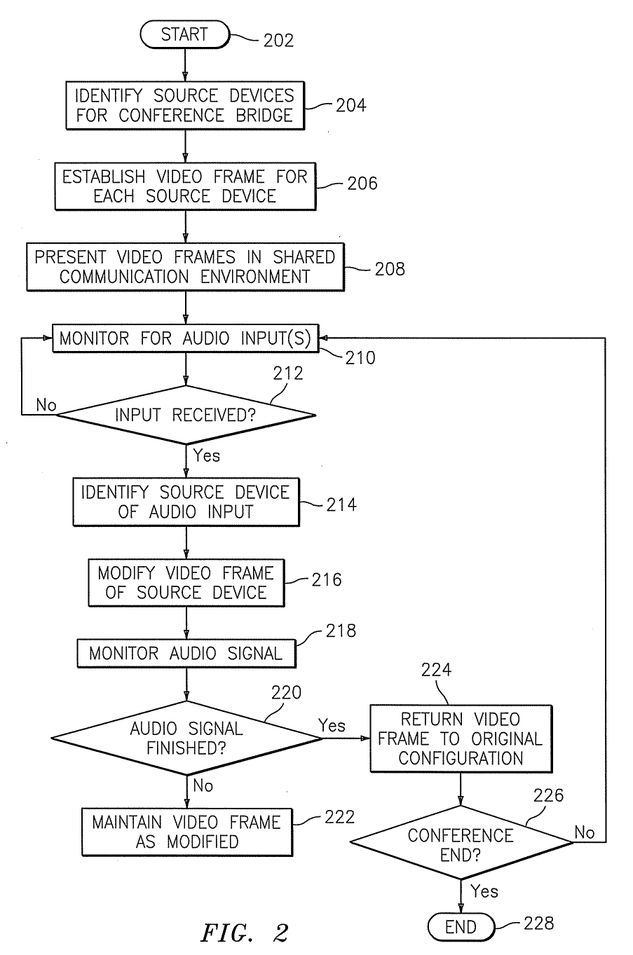

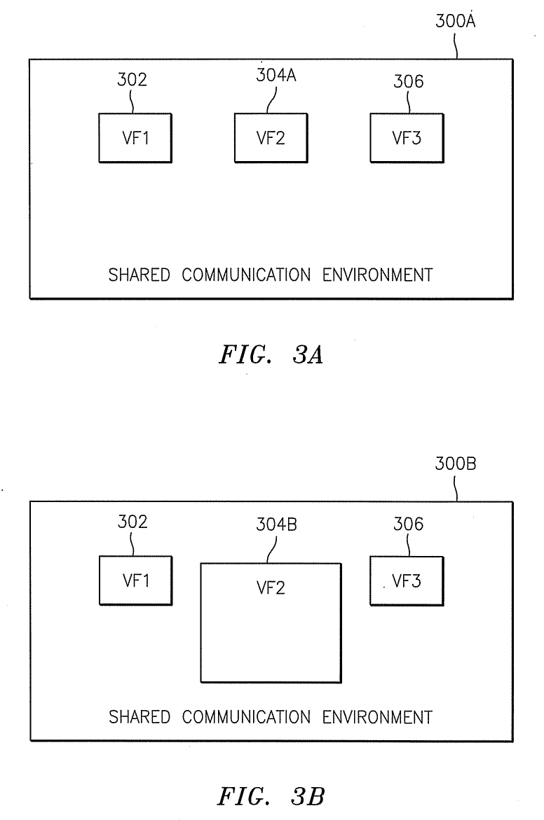

As shown in the system of FIG. 1, host system 102 further implements a conference manager application 112 for conducting the enhanced conferencing services described herein. Using the audio/video conferencing scheme described in the system of FIG. 1, the conference manager 112 modifies content frames for active participants presented in the shared communications environment as will be described in FIGS. 2 and 3.

Network(s) 106 may include any type of known network including, but not limited to, a wide area network (WAN), a local area network (LAN), a global network (e.g. Internet), a virtual private network (VPN), and an intranet. The network(s) 106 may be implemented using a wireless network or any kind of physical network implementation known in the art. A participant client system 104 may be coupled to the host system 102 through multiple networks (e.g., intranet and Internet) so that not all participant client systems 104 are coupled to the host system 102 through the same network. One or more of the participant client systems 104 and the host system 102 may be connected to the network 106 in a wireless fashion.

As described above, and as illustrated in FIG. 1, the conferencing services may be implemented among personal computer devices that are configured with video conferencing components. In alternative exemplary embodiments, other devices may be employed in conducting the conferencing services, such as television monitors communicatively coupled to input/output devices, such as telephones, personal digital assistants, cellular telephones, etc. Thus, the exemplary embodiment shown in the system of FIG. 1 is one of many possible configurations and is not to be construed as limiting in scope.

Turning now to FIG. 2, a flow diagram describing a process for implementing the enhanced conferencing services will now be described in accordance with exemplary embodiments. The process described in FIG. 2 assumes that a videoconference has been scheduled and initiated for three source devices (e.g., participant client systems 104A-104C). The initiation includes identifying the presence of the three participant client systems by input signals received from each respective client systems (e.g., via calling into the host system and establishing a communications session). The process starts at step 202 whereby the conference manager 112 identifies each source device at step 204 via, e.g., an IP address received from the source device.

At step 206, the conference manager 112 establishes a content frame for each identified source device (e.g., participant client systems 104A-104C). Using the video conferencing example above, the content frame established at step 206 may be a video frame. The video frame is generated from a video feed (video inputs) received from the source device over network(s) 106. At step 208, each of the video frames is presented in a shared communications environment. For example, the video frames representing feeds of content are combined and presented as a single content feed over network(s) 106. A sample display screen presenting combined content feeds for a conference is shown in FIG. 3A. The display screen 300A of FIG. 3A illustrates three video frames 302, 304A and 306, each of which corresponds to a conferencing participant (e.g., participant client systems 104A-104C).

At step 210, the conference manager 112 monitors the individual inputs received from participant client systems 104A-104C. The individual inputs are monitored in order to determine an occurrence of a triggering event. As described in the flow diagram of FIG. 2 for illustrative purposes, the triggering event is an audio input signal. However, as indicated above, the triggering event may be any pre-defined event, such as an instance of a video input, a static image, or other defined events. In a video-conferencing application, the triggering event may be defined as an audio signal received from any of the participants in order to identify which of the participants is currently speaking. In another example, a static image may be defined as a triggering event for a conference. The static image, e.g., a medical x-ray image, may be defined as a trigger event so that the content frame depicting the image may be distinguished from other content frames at a given point during the conference as described further herein.

At step 212, it is determined whether the audio input has been received. Alternatively, if the triggering event were related to a video element, the determination performed at step 212 would specify whether a video input has been received. If no trigger event has occurred, the process returns to step 210 whereby the conference manager application 112 continues to monitor the input feeds.

Otherwise, if a trigger event has occurred at step 212 (e.g., a pre-defined audio input signal is received), the conference manager application 112 identifies the source device responsible for the trigger event (e.g., which of participant client systems 104A-104C transmitted the feed which caused the trigger event) at step 214.

At step 216, the content frame (e.g., video frame) corresponding to the source device causing the trigger event is modified. The content frame may be modified in various ways in order to highlight it or distinguish it from the other content frames. As shown in FIG. 3B, a sample display screen 300B illustrates three video frames 302, 304B and 306 whereby video frame 304B (which corresponds to the video frame 304A prior to its modification) has been modified by enlarging its size. Other means of modification may include increasing the volume of an audio feed corresponding to a content frame that caused a trigger event, intermittently flashing a content frame that is subject to the trigger event, displaying a symbol or reference in proximity of the content frame that is subject to the trigger event, etc.

If multiple simultaneous trigger events occur, the conference manager 112 may be configured to select one or more of the content frames to modify based upon pre-defined rules.

At step 218, the conference manager 112 continues to monitor the input feeds to ascertain whether the trigger event is complete. For example, if the trigger event is an audio signal (e.g., a speaker), then the audio signal is monitored to determine whether it has ceased. If the trigger event has completed (e.g., the speaker has finished), at step 220, the content frame is returned to its original form at step 224 (e.g., as shown in display screen 300A of FIG. 3A). Otherwise, the content frame is maintained as modified at step 222.

Once the content frame has been returned to its original form at step 224, the conference manager 112 determines if the conference has completed at step 226. If not, the process returns to step 210 whereby the conference manager 112 continues to monitor the input feeds for a trigger event. If, however, the conference has completed at step 226, the process ends at step 228.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for implementing conferencing services, comprising:
presenting content frames in a shared communication environment, each of the content frames corresponding to a source device that provides input as a participant in a conference;
identifying a source device in response to a trigger event caused by the source device; and
modifying presentation of the content frame corresponding to the identified source device.

2. The method of claim 1, wherein the source device is a teleconferencing-enabled system comprising at least one of:
a personal computer;
a personal digital assistant;
a cellular telephone;
a television; and
a telephone.

3. The method of claim 1, wherein the trigger event includes an occurrence of a defined event comprising at least one of:
an audio input;
a video input; and
a static image.

4. The method of claim 1, wherein the content frame is a video frame, the modifying including enlarging the video frame corresponding to the identified source device.

5. The method of claim 1, wherein the content frame is a video frame, the modifying including increasing the volume of an audio feed corresponding to the identified source device.

6. The method of claim 1, further comprising selecting a content frame to modify upon a determination of simultaneously occurring trigger events.

7. A system for implementing enhanced conferencing services, comprising:
a computer processing device; and
a conference manager application executing on the computer processing device, the conference manager application implementing:
presenting content frames in a shared communication environment, each of the content frames corresponding to a source device that provides input as a participant in a conference;
identifying a source device in response to a trigger event caused by the source device; and
modifying presentation of the content frame corresponding to the identified source device.

8. The system of claim 7, wherein the source device is a teleconferencing-enabled system comprising at least one of:
a personal computer;
a personal digital assistant;
a cellular telephone;
a television; and
a telephone.

9. The system of claim 7, wherein the trigger event includes an occurrence of a defined event comprising at least one of:
an audio input;
a video input; and
a static image.

10. The system of claim 7, wherein the content frame is a video frame, the modifying including enlarging the video frame corresponding to the identified source device.

11. The system of claim 7, wherein the content frame is a video frame, the modifying including increasing the volume of an audio feed corresponding to the identified source device.

12. The system of claim 7, wherein the conferencing manager application further implements:
selecting a content frame to modify upon a determination of simultaneously occurring trigger events.

13. A computer program product for implementing enhanced conferencing services, the computer program product executing instructions for implementing a method, the method comprising:
presenting content frames in a shared communication environment, each of the content frames corresponding to a source device that provides input as a participant in a conference;
identifying a source device in response to a trigger event caused by the source device; and
modifying presentation of the content frame corresponding to the identified source device.

14. The computer program product of claim 13, wherein the source device is a teleconferencing-enabled system comprising at least one of:
a personal computer;
a personal digital assistant;
a cellular telephone;
a television; and
a telephone.

15. The computer program product of claim 13, wherein the trigger event includes an occurrence of a defined event comprising at least one of:
an audio input;
a video input; and
a static image.

16. The computer program product of claim 13, wherein the content frame is a video frame, the modifying including enlarging the video frame corresponding to the identified source device.

17. The computer program product of claim 13, wherein the content frame is a video frame, the modifying including increasing the volume of an audio feed corresponding to the identified source device.

18. The computer program product of claim 13, further comprising instructions for implementing:
selecting a content frame to modify upon a determination of simultaneously occurring trigger events.
